(19) United States
(12) Patent Application Publication
(10) Pub. No.: US 2005/0063251 A1
(43) Pub. Date: Mar. 24, 2005

(54) DYNAMIC GENERATION OF VECTOR GRAPHICS AND ANIMATION OF BOTTOM HOLE ASSEMBLY

(75) Inventors: JONATHAN GUIDRY, PEARLAND, TX (US); MINH TRANG CHAU, SUGAR LAND, TX (US)

Correspondence Address: SCHLUMBERGER OILFIELD SERVICES, 200 GILLINGHAM LANE, MD 200-9, SUGAR LAND, TX, 77478, US

(73) Assignee: SCHLUMBERGER TECHNOLOGY CORPORATION, SUGAR LAND, TX (US)

(21) Appl. No.: 10/710,823

(22) Filed: Aug. 5, 2004

Related U.S. Application Data
(60) Provisional application No. 60/500,189, filed on Sep. 4, 2003.

(51) Int. Cl. G01V 1/00; G01V 3/18

(52) U.S. Cl. 367/35; 367/25; 367/53; 367/73; 367/69; 324/366; 324/351

(57) ABSTRACT

A method for displaying a bottom-hole assembly (BHA) using vector graphics includes parsing and interpreting BHA source data to produce data packets corresponding to BHA components; assembling the BHA using vector graphics components in a vector graphics library, wherein the vector graphics components represent the BHA components; and displaying the BHA at a selected scale.

### CROSS REFERENCE TO RELATED APPLICATIONS

This claims priority, under 35 U.S.C. §119, of a Provisional Application Ser. No. 60/500189, filed Sep. 4, 2003. The content of this Provisional Application is incorporated by reference in its entirety.

### BACKGROUND OF INVENTION

1. Field of the Invention

The invention relates generally to methods and systems for analyzing data generated in oilfield exploration. More particularly, the invention relates to methods and systems that facilitate the analysis of bottom-hole assembly data.

2. Background Art

Wells are generally drilled into the ground to recover natural deposits of oil and gas trapped in geological formations. While the well is being drilled or after it is drilled, drillers often investigate the formation and its contents using various sensors, such as resistivity sensors, nuclear magnetic sensors, neutron sensors, gamma ray sensors, etc. These sensors may be lowered into the well on a wireline to take measurements after the well is drilled. Alternatively, the measurements or logging may be performed while drilling (MWD or LWD). With MWD or LWD, the sensors are included in a bottom hole assembly (BHA). A typical BHA includes the drill bit and a plurality of subassemblies (subs) that house various sensors. Data may be obtained about the borehole and drilling fluid properties in the borehole or about the properties of the formation and formation fluids. These data are generally referred to as downhole data.

Due to enormous costs associated with drilling a well, it is imperative that the drilling process be carefully planned. Factors to consider in planning a drilling process include, for example, what components and sensors to include in the bottom-hole assembly and what is the most efficient path (trajectory). The various components to be included in the BHA should be assembled and inspected before hand to identify any possible problems or complications. However, it may not be practical to assemble all the BHA components to test all possibilities before each job. Therefore, it is desirable that the well plan, especially the BHA and drill string assembly, can be graphically displayed to facilitate the planning process. In addition, graphical displays are also needed in the analysis of data obtained from a drilling operation. Co-pending applications Ser. Nos. 10/708,929 filed Apr. 1, 2004, 10/604,062 filed Jun. 24, 2003, and 10/250,049 filed May 30, 2003 disclose various graphical displays that facilitate the analysis of data obtained from a drilling operation.

FIG. 1 shows a general scheme used in most prior art methods for displaying BHA graphics. As shown, the BHA data input 11 are used by a graphics display process 12 (e.g., a bitmap or raster graphics display process) to produce a graphics of the BHA 13. The graphics display process 12 may draw the BHA graphics as surface maps (bitmaps) or assemble the BHA graphics from components in a pre-built graphics library (e.g., an open GL library). These displays are typically of the raster (or bitmap) type, which cannot be scaled without losing the display quality.

Several prior art methods are available for graphical display of BHA. For example, the BHA editor in Drilling Office™, from Schlumberger Technology Corp. (Houston, Tex.), helps create a bottom-hole assembly (BHA) and well geometries for use in torque and drag analysis applications. Components and tools easily can be customized so that a current location or rig inventory can be maintained. Similarly, WinSurv™ from the Performance Drilling Technologies, Inc. of Houston, Tex., provides raster drawings of BHA. BHASyS™ program from Baker Hughes (Houston, Tex.) and BHA Design™ from DrillingSoftware L.L.C. (Sacramento, Calif.) can also display BHA in bitmaps.

While these prior art applications are capable of displaying BHA and various components, the displayed BHA cannot be readily changed (e.g., zoom in or zoom out) without losing the display quality. Therefore, there still exists a need for convenient methods and systems that permit the user to manipulate the BHA display without losing the detail and quality of the displayed BHA components.

### SUMMARY OF INVENTION

One aspect of the invention relates to methods for displaying a bottom-hole assembly (BHA) using vector graphics. A method in accordance with one embodiment of the invention includes parsing and interpreting BHA source data to produce data packets corresponding to BHA components; assembling the BHA using vector graphics components in a vector graphics library, wherein the vector graphics components represent the BHA components; and displaying the BHA at a selected scale.

One aspect of the invention relates to systems for displaying a bottom-hole assembly (BHA) using vector graphics. A system in accordance with one embodiment of the invention includes a processor and a memory, wherein the memory stores a program having instructions for: parsing and interpreting BHA source data to produce data packets corresponding to BHA components; assembling the BHA using vector graphics components in a vector graphics library, wherein the vector graphics components represent the BHA components; and displaying the BHA at a selected scale.

Other aspects and advantages of the invention will be apparent from the following description and the appended claims.

### BRIEF DESCRIPTION OF DRAWINGS

FIG. 1 shows a prior art method for the display of a BHA.

FIG. 2 shows a BHA display method in accordance with one embodiment of the invention.

FIG. 3 illustrates a schematics of a BHA display method in accordance with one embodiment of the invention.

FIG. 4 shows examples of components in a vector graphics library in accordance with one embodiment of the invention.

FIG. 5 shows a method of assembling a BHA components from separate features in accordance with one embodiment of the invention.

FIG. 6 shows a BHA source data and graphics display in accordance with one embodiment of the invention.

FIG. 7 shows a BHA source data and graphics display in accordance with one embodiment of the invention.

FIG. 8 shows a BHA source data and graphics display in accordance with one embodiment of the invention.

FIG. 9 shows a BHA graphics display animation in accordance with one embodiment of the invention.

FIG. 10 shows three frames of animation displays, illustrating vector graphics animation using data streamed in real-time from down hole measurements, in accordance with one embodiment of the invention.

FIG. 11 shows a prior art computer system that can be used with embodiments of the invention.

### DETAILED DESCRIPTION

Embodiments of the invention relate to methods and systems for displaying bottom-hole assembly (BHA), using vector graphics to represent the components of a BHA. VG drawings can be dynamic and interactive. Vector graphics permits a user to manipulate and scale the BHA components according to the relative scale (dimension) of the components, while maintaining the “quality” of the display.

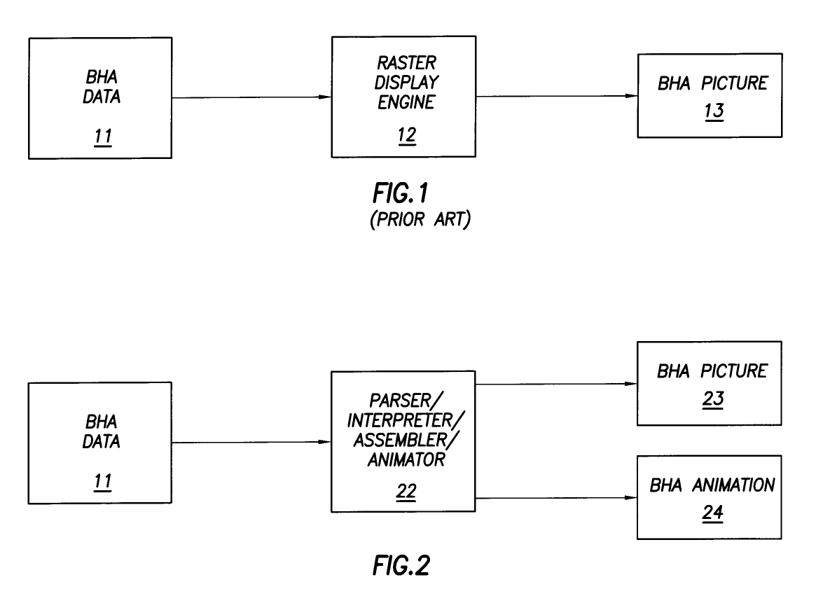

As noted above and illustrated in FIG. 1, conventional methods display a BHA in bitmap graphics. As shown in FIG. 1, the BHA data 11 is rendered by a graphics display process 12 (e.g., a bitmap or raster graphics display process) to produce a bitmap graphics of the BHA 13. The bitmap picture cannot be scaled or rotated. Every time a new scene is created due to zoom or rotation, the BHA picture needs to be redrawn. Thus, the bitmap pictures cannot be efficiently used to produce animation.

FIG. 2 illustrates a general scheme for displaying a BHA, using vector graphics and animation, in accordance with one embodiment of the invention. As shown, the BHA data 21, which may be in a selected file format (e.g., WITSML data), is converted by a graphics display process of the invention 22 to produce a vector graphic display of the BHA 23 or the animation of the BHA 24. As shown the graphics display process 22 of the invention may comprise: a parser, an interpreter, an assembler, and an animator. In contrast to the conventional display, a display of the invention generates vector graphics that can be easily manipulated (zoom and rotate). Therefore, the display of the invention can also be used to provide animation of the BHA.

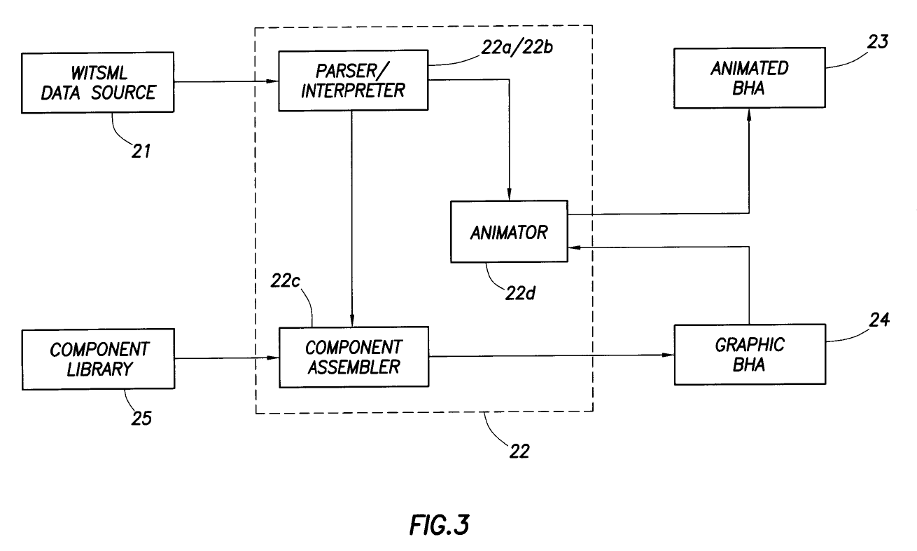

FIG. 3 shows one embodiment of the invention, in which a graphics display process 22 of the invention includes the following subroutines: a Parser/Interpreter 22a/22b, an Assembler 22c (for vector graphics), and an Animator 22d (for animation).

As shown, the Parser 22a receives the BHA data 21 (e.g., the WITSML data) and extracts all relevant data. A parser is a specialized software program that recognizes the data format (e.g., the WITSML markup) in a document. The Parser 22a checks whether a document contains all the required elements. If so, it parses data into packets and passes the data packets to the Interpreter 22b. The Interpreter 22b recognizes the data packets to correlate them with the proper graphics components (e.g., BHA components). The Interpreter 22b then transfer the interpreted (correlated) BHA components to the Assembler 22c. The Assembler 22c composes the BHA graphic from vector graphics components stored in a component library 25 (which will be described in detail later) and applies a scale factor to render the BHA. One of ordinary skill in the art would appreciate that each of the modules, the Parser 22a, the Interpreter 22b, and the Assembler 22c, may be coded in any suitable scripting or programming language and may take advantage of existing commercial standard, such as the ActiveX controls or Shockwave technology.

The resulting output from the Assembler 22c is a graphical representation of the BHA data (e.g., WITSML tubular data). This graphic can be displayed in any application (or browser) that can display the components according to the predefined rules, such as ActiveX controls or Shock-wave plug-in.

In some embodiments, additional data (e.g., from another WITSML data source) may be included to animate the BHA display. For example, the BHA graphic may be animated by the Animator 22d to rotate and/or to follow a trajectory or a depth-versus-time log.

The Animator 22d generates a time-line and the motion path that the graphic BHA will follow. The entire process to read, parse, assemble and animate the BHA may be completed in a few seconds. The resulting movie's length depends on the amount of data provided. The data for the animation may be included in the BHA source file that is used to generate the BHA graphics. Alternatively, the animation data may be supplied in a separate file or be supplied via a data socket connection to the BHA display process. With the socket connection, the BHA data and the associated data may be streamed in real time to the control, resulting in a completely dynamic animated BHA.

The data source files to be used with embodiments of the invention may be in any suitable format. For example, a Wellsite Information Transfer Specification Markup Language (WITSML) data file, any text or binary formatted file may be used. In addition, the data may be streamed from another application via a socket (e.g., an XML Socket) or internal memory data structure passed through an interface (e.g., COM or COM+). WITSML, which is a formatted text file, is a new standard for drilling information transfer. WITSML may include simple text descriptions of BHA, trajectories, drilling mechanics, and other drilling and completions data. For complete details on the WITSML schema see http://www.witsml.org.

The BHA Schematic control may be written in any suitable program, such as Flash MX™ from Macromedia (San Francisco, Calif.). Components may be drawn using, for example, Flash's native tool. Each component may be mapped to a specific tubular type and stored in an internal library (shown as 25 in FIG. 3). The BHA schematic control may be embedded in an application (e.g., a Web browser). In this case, it may read the first “tubular” node (e.g., a WITSML tubular node) from the specified data source and dynamically generate a schematic image of the BHA using the components from the library.

As shown in FIG. 3, a library of components may be provided in accordance with one embodiment of the invention. The library 25 provides the Assembler 22c with a set of predefined components, which can be readily scaled and assembled to from the display specified by the input data. The components in the library may include most or all components that are commonly used in the industry. For example, these components may include stabilizers (including spiral, straight, rotating, and non-rotating stabilizers), thrusters, adjustable bend housing, accelerator, bits (fixed cutter bits and roller cone bits), under reamers, hole opener, drill pipes, jars, collars, power packs (e.g., downhole generators, motors), and various sensors and instruments (e.g., ARC™ tool, AIM™ tool, etc.). These components will be drawn as vector components, instead of bitmap, JPEG, or raster graphics components. Alternatively, some or all of the VG components may be generated directly from the source data instead of retrieving them from the library.

The components may be drawn in different colors and/or different shades of gray. In addition, the tools may be drawn with gradient fills, where appropriate, to facilitate visual identification of various BHA components/materials or to enhanced the three-dimensional perception. Furthermore, different transparencies may be used, if desired, to improve the overall visualization of the various BHA components, such as to visualize a component that is otherwise obscured by other components. In preferred embodiments of the invention, a standard schemes of colors and gradients may be used to display parts of BHA components such that the final display is represented in a congruous color scheme. Furthermore, in some embodiments, all gradients may be of the same shading scheme with only different colors. Thus, when two different components types are assembled, their shadings match to give a continuous tubular perception.

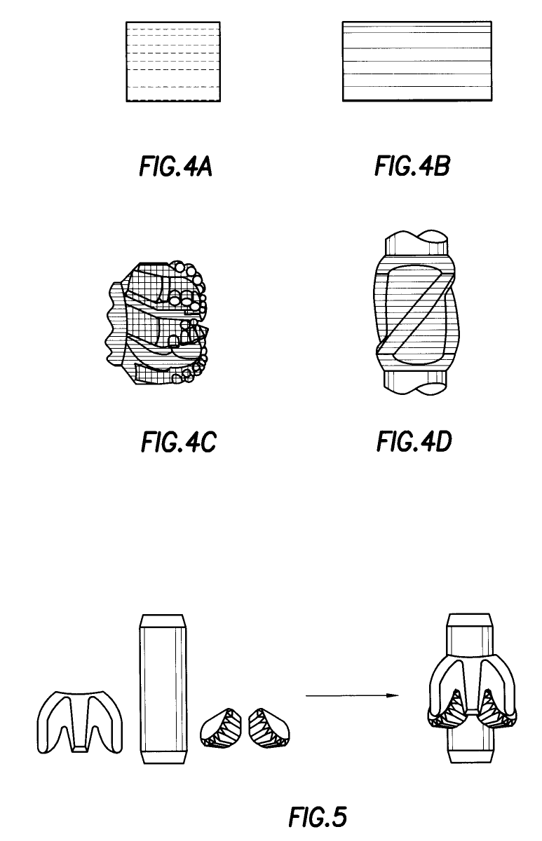

FIG. 4 shows some examples of BHA components that are commonly used in a drilling process. These components may be described as vector graphics and stored in the library for later retrieval. For example, FIG. 4A shows a standard pipe, collar, or a generic tool component. The default color for the body and the features of components may be a grayish gradient, for example. The gradient preferably resembles a metallic cylinder. FIG. 4B shows a special non-magnetic tool having a different gradient, using a bluish tint. The use of different gradient or color/tint may be selected to provide a visual cue that these components are made of different materials and/or have different properties. On the other hand, same color and gradient schemes may be used for components belonging to the same group. For example, all cutters for bits, reamers, and hole openers may be represented in the same gradient (e.g., a gold gradient) with a different color (e.g., dark blue) gradient for the stabilizer blades (FIG. 4C). FIG. 4D shows an example of a stabilizer blade. The stabilizer blade may be displayed in the same color scheme (e.g., dark blue gradient) as those found in the drill bit (FIG. 4C) such that all stabilizer blades are readily identified along the entire drill string.

In addition, different sensors (not shown), such as button electrodes and ring electrodes, may be provided with different coloring and/or gradient schemes to facilitate visual identification of various sensors. In some embodiments, different tool components marketed by different venders may also be provided with a different coloring or gradient scheme so that an operator can visually differentiate different parts.

Most components have top and bottom connections. However, bits and hole openers have only top connections. In addition, components that have pin (male connectors) or box connectors (female connectors) that will not be visible when assembled may be represented as having no such connectors. Each connection in these components preferably has the same dimension so that when different components are assembled, they match.

In accordance with some embodiments of the invention, components may be built from a basic body. For example, a basic body may have a constant width (i.e., diameter) but different lengths to accommodate additional features (e.g., blades, sensors, cutters, etc.). Features that will be added to a components may be grouped separately from the body of the component. Each feature may also be individually grouped. These individual features can then be assembled to form a component. For example, FIG. 5 shows a hole opener assembled from separate features (parts).

Some embodiments of the invention relate to software application controls that can be embedded in any application supporting the selected controls (e.g., ActiveX controls) or viewed in any web browser with graphic interpreter module (e.g., the Shockwave™ plug-in from Macromedia, Inc., San Francisco, Calif.). A user of the invention will provide a data source (e.g., WITSML source data) containing a tubular object. As noted above, the data source may be a data file, the path to a file stored on a local drive or a server, or the port of an XML socket. The data file may be in any suitable format, such as simple text or WITSML.

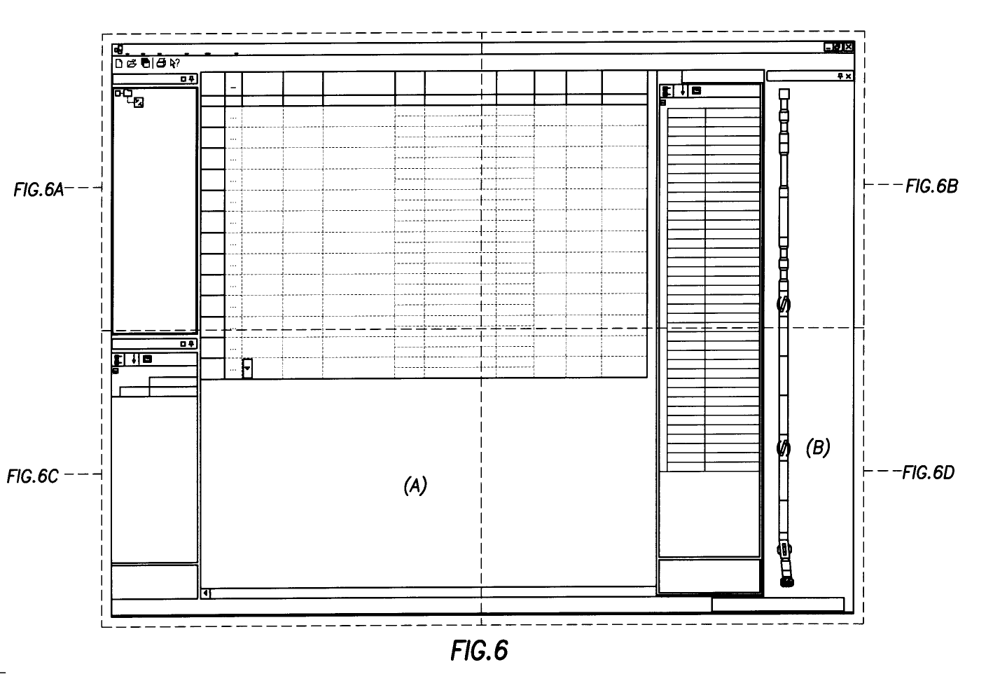

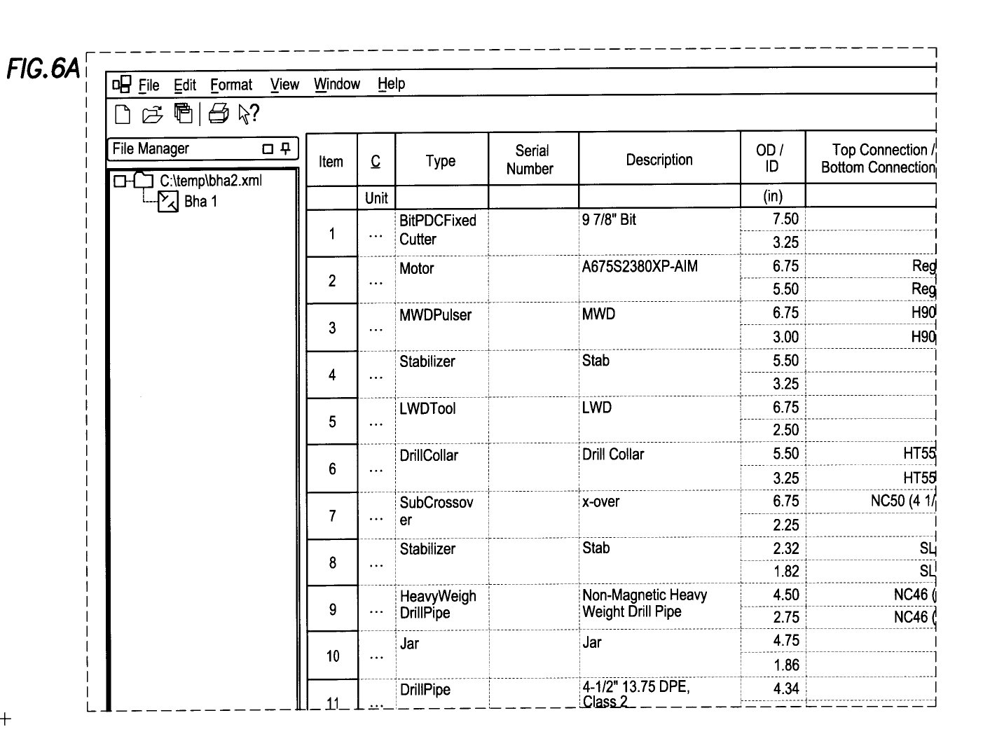

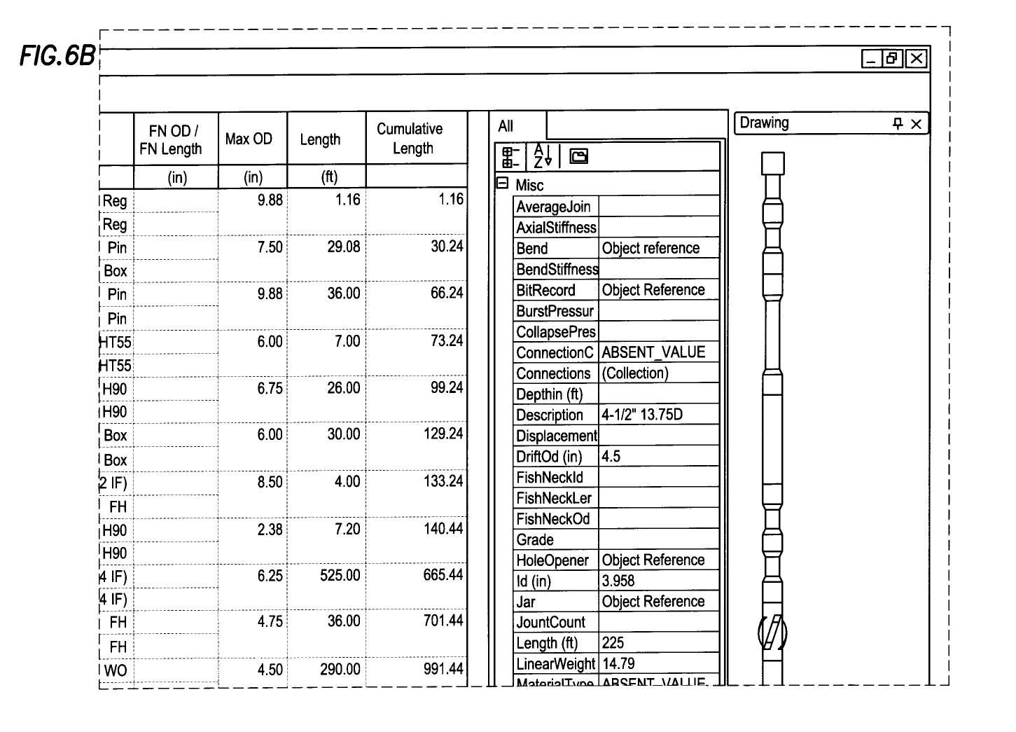

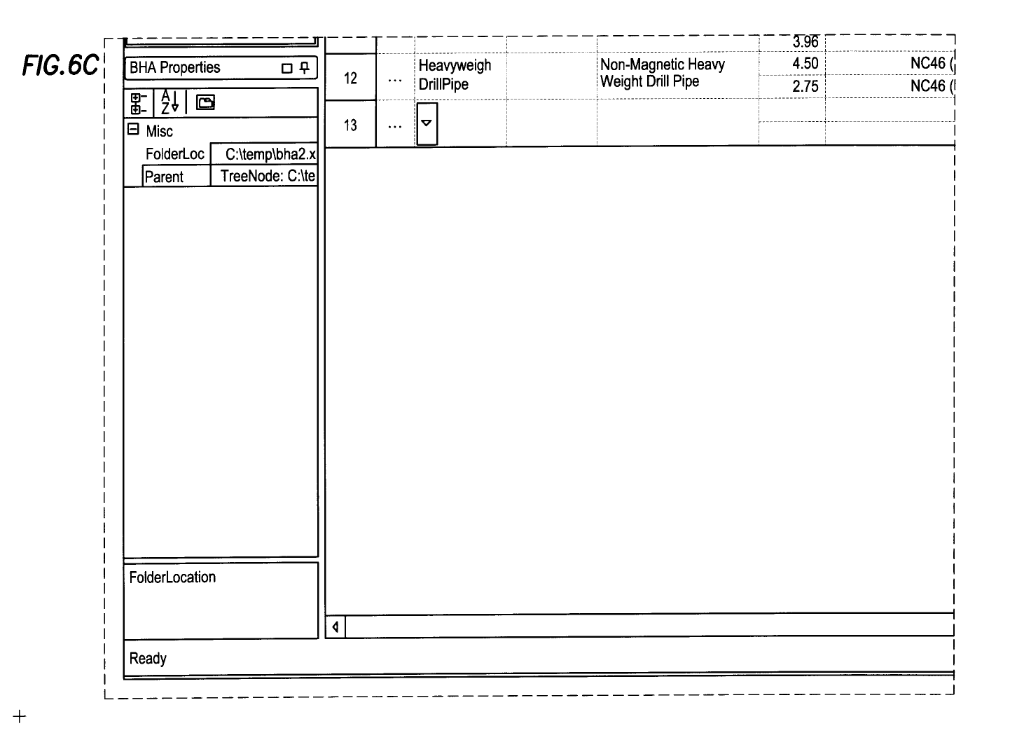

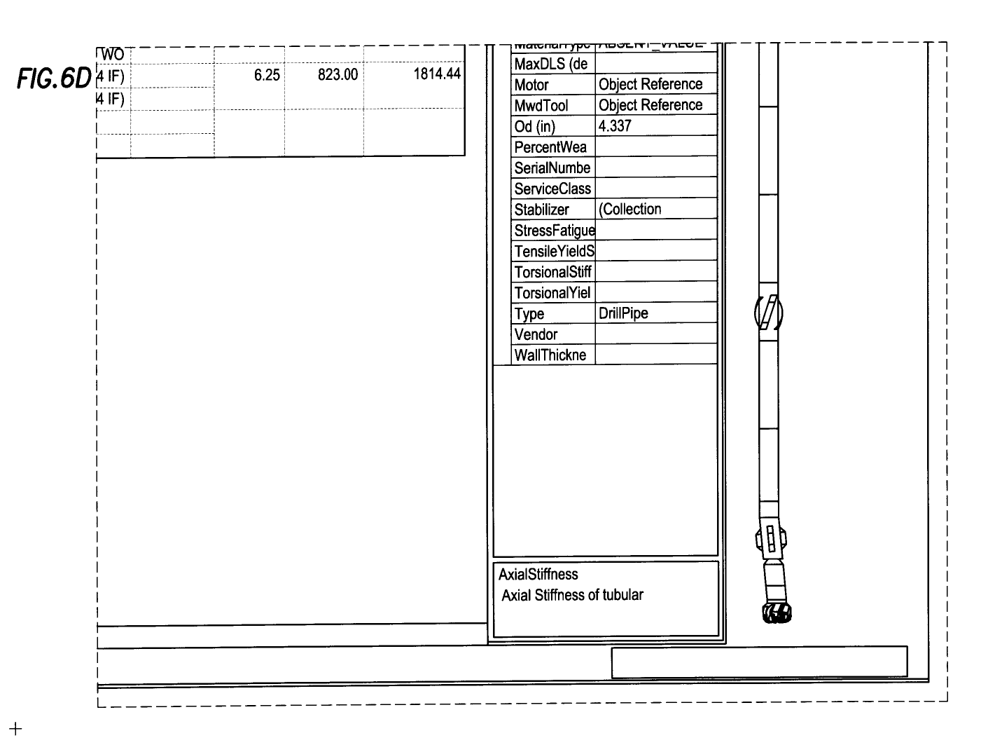

FIG. 6 illustrates one embodiment of the invention that shows a BHA display embedded in an application. In this embodiment, the window has at least two components. The drawing (panel B) is a graphical representation of the data in panel A. Any changes made to the data in panel A may be automatically reflected in the drawing in panel B.

Panel A in FIG. 6A-D shows the WITSML data in tabular form. This display provides an easy to read version of the WITSML data and provides the mechanical image data that is needed to generate the graphical representation shown in panel B, see FIG. 6B and FIG. 6D.

Panel A in FIG. 6 also illustrates the builder feature of a method in accordance with the invention, in which the drill string components may be added and manipulated by the user onto the component list. The components may be selected, for example, from an existing component library (shown as 25 in FIG. 3) or generated in real time. According to another embodiment of the invention, the data may be simply read into the table form an existing WITSML or other suitable file formats (e.g., a text file), without being displayed.

The BHA-drill string display in panel B of FIG. 6B and FIG. 6D provides a scalable visual representation of the drill string and the BHA. The display may include the relative placements of the components along the drill string. This provides a visual aid, from which an experienced technician can easily detect and correct any errors in the design. For example, are the stabilizers situated at proper placements (axial locations) along the drill string? In addition, the drill string graphics display may include a display of configuration errors. For example, an error flag may be displayed when a component selected from a library or read from a file is not included with the proper connecting components. Errors may be also included according to a set of predetermined rules based on existing drill string requirements. For example, an error message may be displayed indicating that an additional stabilizer is needed and a suggestion for placement is provided.

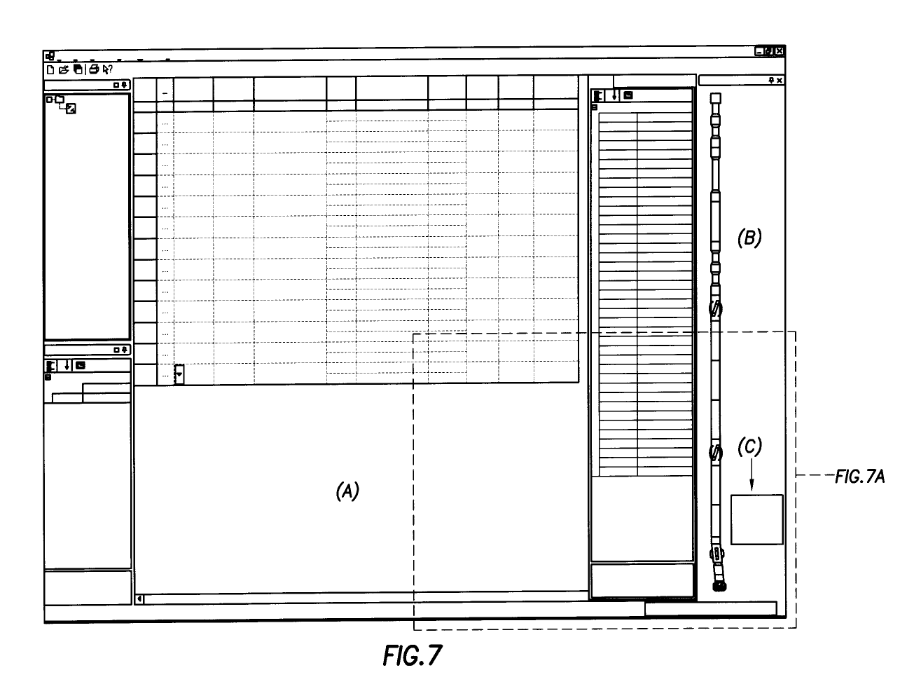

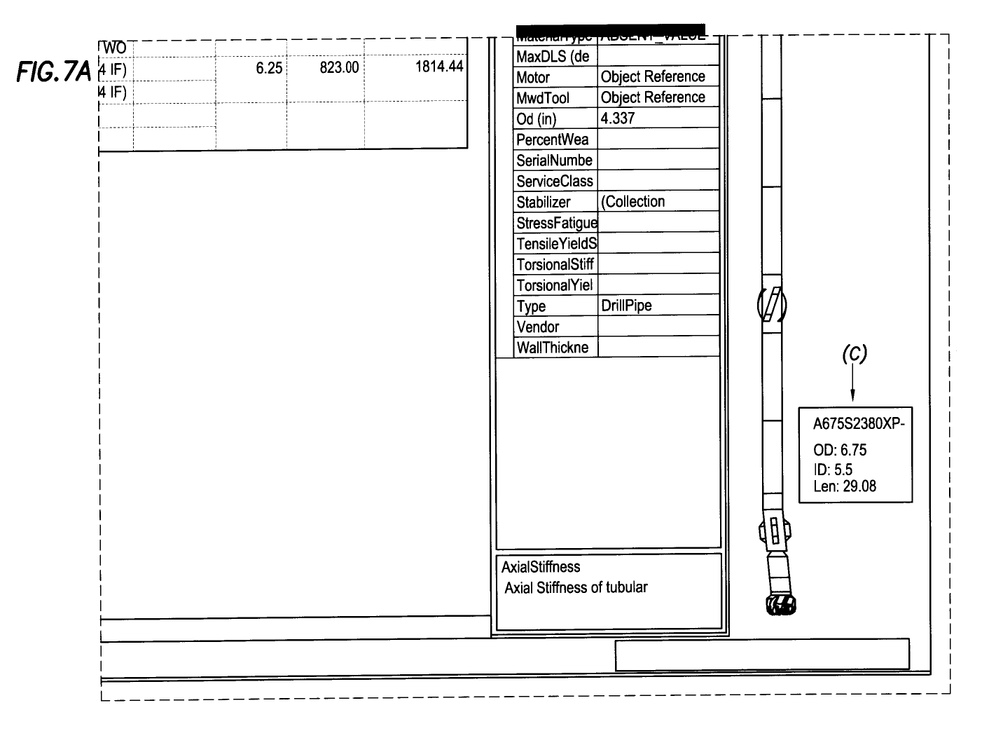

In accordance with some embodiments of the invention, some interactive features may be included in the graphics display. For example, FIG. 7A shows that a pop up window (or drop down window) (Panel C) may be used to display information related to a selected component of the BHA. The selection (or activation of the pop-up window) may be accomplished by moving the pointer (mouse or cursor) over a BHA component, by clicking on the BHA component, by touch screen selection, or by any suitable selection means. The drop-down or pop-up window may display the component description and/or other relevant data. Because each component in the displayed graphics is synchronized with the data listed in the table, this provides a convenient inquiry mode as an alternative to locating the same information directly from the file or data table.

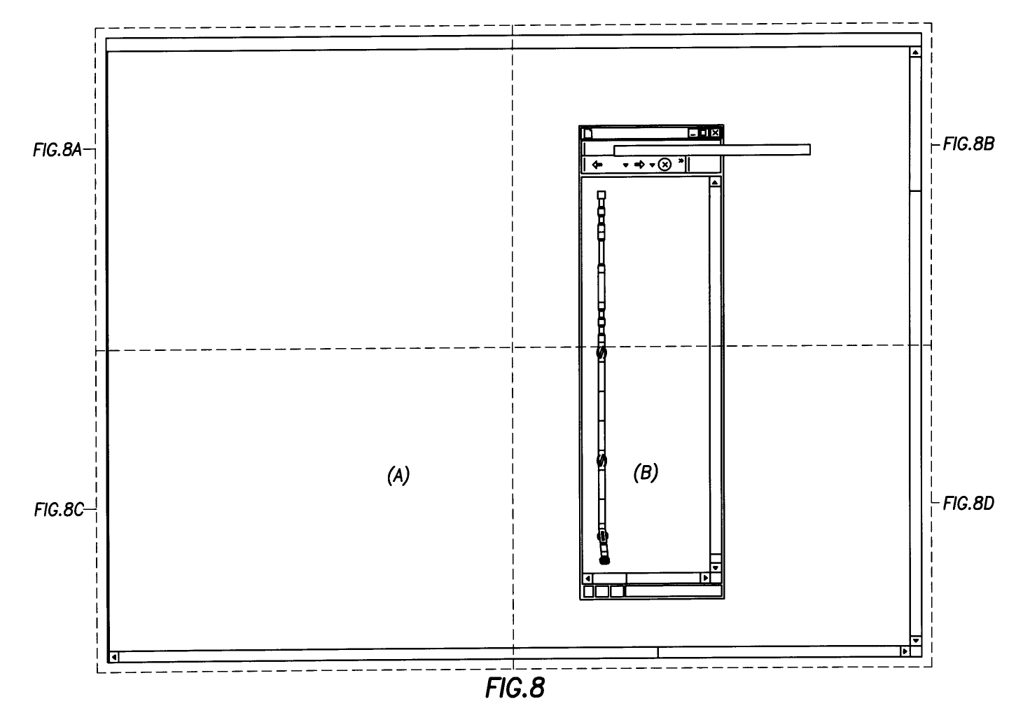

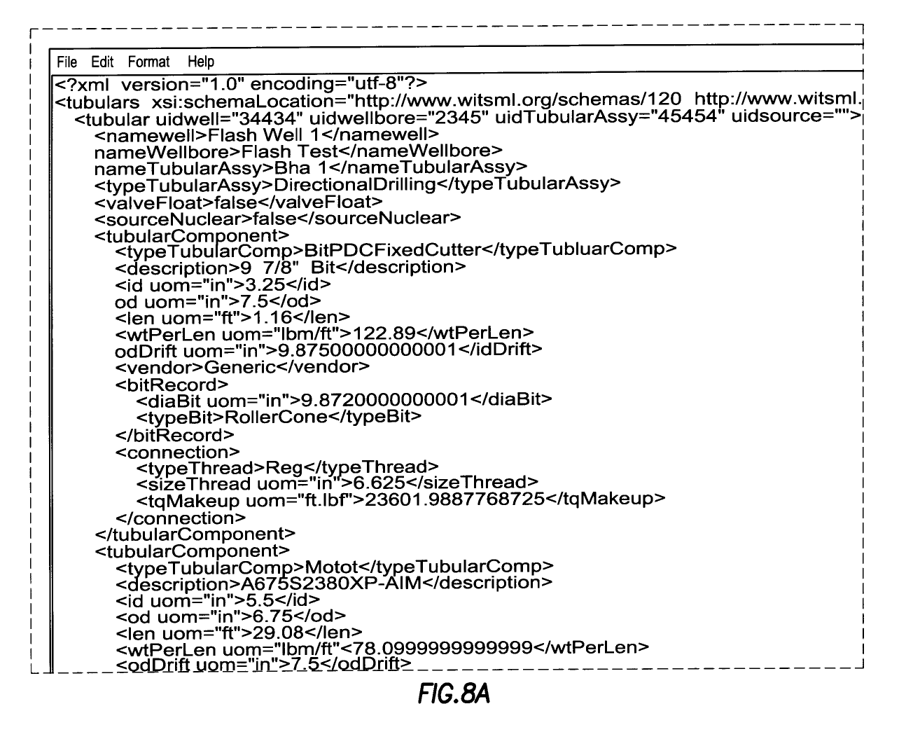

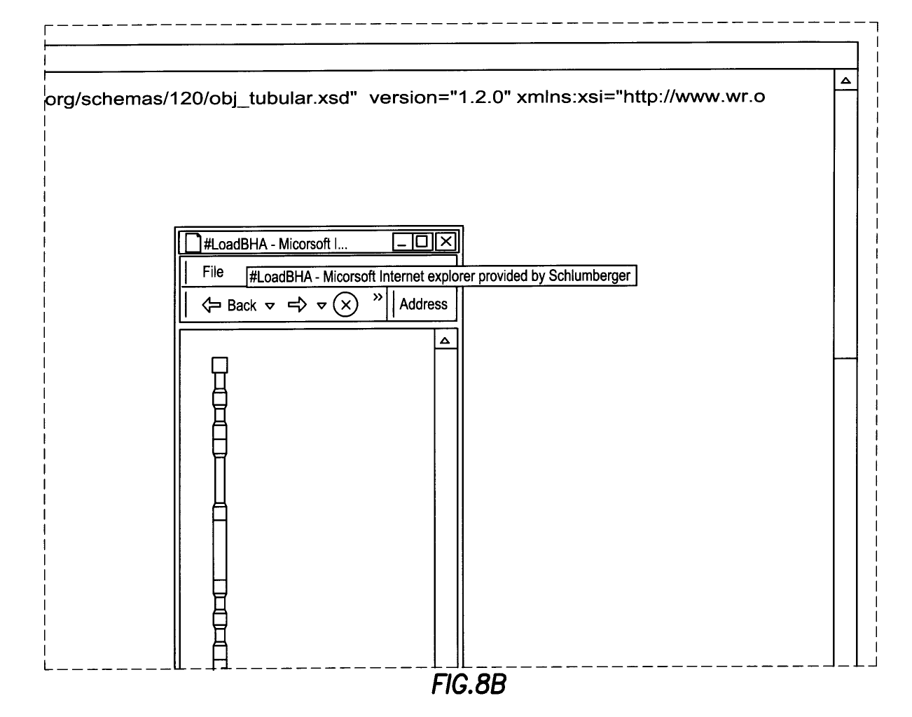

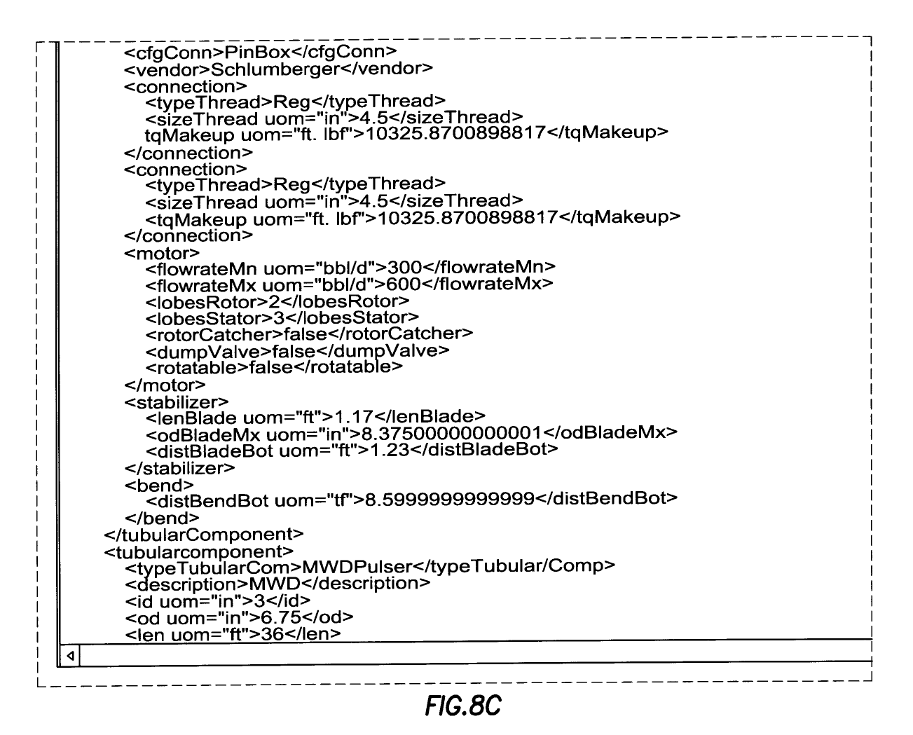

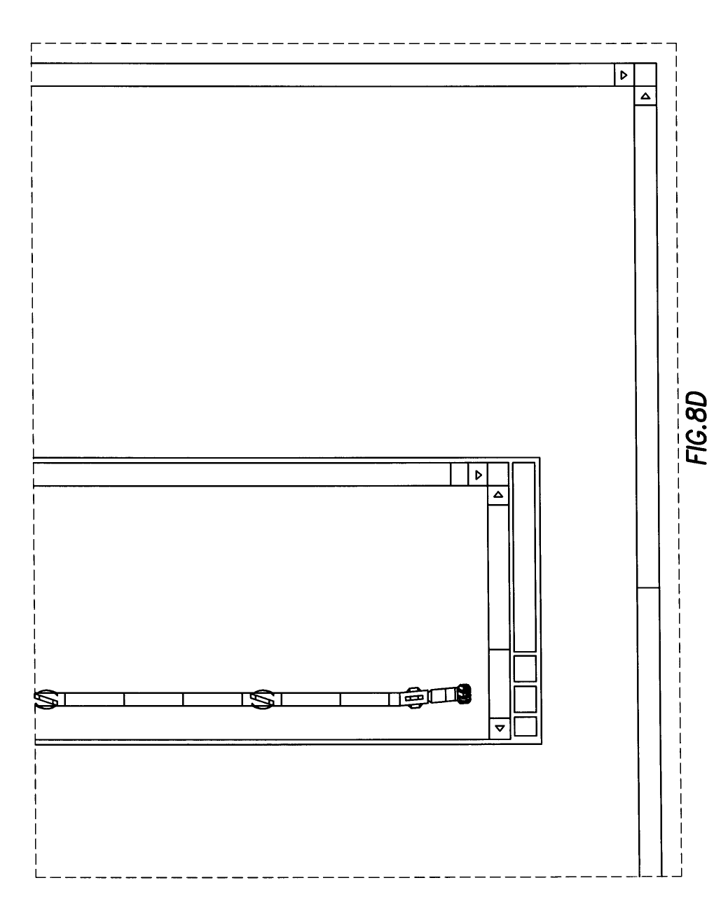

As noted above, embodiments of the invention may be embedded in another application (e.g., a web browser). FIG. 8 illustrates one example in which the graphic window (B) is embedded in a web browser (A). The web browser (A), shown in FIG. 8A-8D, display the BHA source data, which is a text file. Any changes to the BHA source data in the web browser (A) may be immediately reflected in the graphic display (B). In accordance with embodiments of the invention, the web browser (or equivalent) window (A) and the graphics display window (B) may be independent of each other so that the graphic window (B) may be displayed at any location relative to the browser window (A). While these windows are independent of each other, they may be functionally linked (synchronized) such that any changes in the text file (the BHA source file) may be immediately reflected in the graphics display. FIG. 8 also illustrates the simple approach of embodiments of the invention. That is, using an embodiment of the invention, the BHA graphics can be generated from a text file and a web browser.

Embodiments of the invention described above create graphical representations of the drill strings and BHA from simple input files, such as WITSML tubular data. Some embodiments of the invention further provide the capability to animate the graphics display, if the trajectory or time-versus-depth data is provided. These embodiments of the invention will animate the BHA along the trajectory and produce a movie that can be controlled much like a VCR (play, rewind, forward, pause). Because the graphic displays of the invention are produced from simple input data files and the displays can be quickly updated, the animation process will not have much time lag.

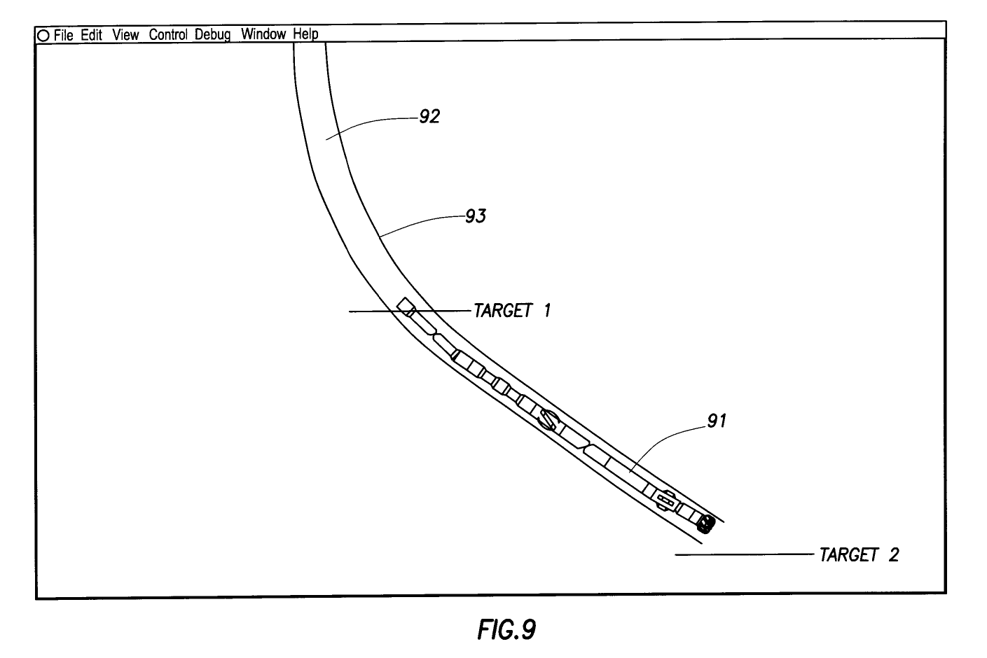

FIG. 9 illustrates one embodiment of the invention for animating the BHA display. To animate the BHA trajectory, data for the BHA, time, and the trajectory are needed. The data for the BHA are for generating the graphics. As noted above, the data for BHA may be simple text files or markup language files. Alternatively, the source data may be generated by another application and provided to the data socket of a display program.

As shown in FIG. 9, the BHA 91 drills along a borehole (trajectory) 92 from target 1 to target 2. After drilling, the borehole may be lined with a casing 93. Embodiments of the invention may optionally display the borehole trajectory together with the BHA/drill sting. The borehole trajectory and the casing may be displayed as sections of cylinders. These cylinders may be displayed with various degrees of transparency so that the BHA-drill string remains visible. The borehole (or trajectory) may be displayed section by section to simulate a drilling process. The casing may be animated as it is being run; then, it may become a static part of the wellbore after it is cemented.

Embodiments of the invention may animate the process of the BHA 91 drilling the borehole 92 and the process of the installation of the casing 93. The animation of the BHA 91 drilling the borehole 92 may include showing the rotation and/or vibrations of the BHA. The data for the animation may be provided from an actual drilling operation or from a well planning.

The well trajectory data, which may also be a text file (e.g., WITSML data), are used to generate a path of the wellbore, which may be static or may include real-time components. The well trajectory data may or may not be included in the BHA source data file. The well trajectory data may be from well plan data that is generated from a well planner software. Alternatively, the trajectory data may be survey data captured during a drilling operation. The wellbore data captured during a drilling operation may be streamed in real time to the application to produce the animation.

Instead of well trajectory data, time-versus-depth data, which may also be a text file (e.g., WITSML data), may be used to provide the position relative to the wellbore path or the depth of the drill bit. The time-versus-depth data may be from well planner or from measurement log. Alternatively, these data may be from survey data captured during a drilling operation. The data captured during a drilling operation may be streamed in real-time to an application of the invention to animate the BHA.

In one embodiment of the invention, a full view of the drill string may be shown along the trajectory including the BHA and all or a significant portion of the drill pipe. A smaller view may be concurrently shown as a zoomed view of the BHA, including the bit, motor, and measurement equipment. Having two displays of different scales may provide a clearer view of the animation.

The animation features may include real-time representation of rotation, trajectory, or torsional stress. This information may be indicated by color intensity or other color changes.

Embodiments of the invention may be used in a wide range of applications. For example, embodiments of the invention may be used in planning a wellbore trajectory, e.g., in modeling whether a particular wellbore angle conflicts with drill string component design. These methods allow for trial and error model analysis prior to drilling.

The displays of BHA may be used in torque and drag analysis and cuttings management. They may also be used in modeling. For example, will a BHA design handle the torsional stresses of a particular trajectory or drilling rate or mud system? Embodiments of the invention allows trial and error model analysis prior to drilling.

Embodiments of the invention may also be used in real-time representation of a drilling operation. The application of the invention may receive downhole measurements and display BHA responses to the drilling environment. Embodiments of the invention may also be used to view the history of operation (play back feature) to allow a technician to review a section which had been previously drilled, for example, for efficiency or failure analysis.

Although the invention is described in the context of displaying a BHA, many other applications exist. One of ordinary skill in the art would appreciate that modifications are possible without departing from the scope of the invention. Vector graphics (VG) allows for three types of graphic objects: vector graphic shapes (e.g., paths consisting of straight lines and curves), images, and text. Thus, one can also display data related to the wellbore, the formation, and/or the BHA alongside the BHA display. Such data (formation data, BHA data, wellbore data) are referred to generally as “well log data” in this description.

SSome embodiments of the invention may include display of well log data along a wellbore, e.g., formation data (e.g., types, density, resistivity, etc.), gamma ray data, and NMR data. Some embodiments of the invention may also display data related to the properties or data of the BHA or drill string, such as weight on bit (WOB), rotation per minute (RPM), rate of penetration (ROP), torque, drag, shocks, etc. Such displays may be by changing colors of components to reflect the stress or the rotation speeds. Similarly, display of torque and drag data may be by bending or color coding components that are under torsional stress, and display of shocks may be by vibrating components that are receiving shocks.

SSome embodiments of the invention provide inquiry modes in which some or all of these related data may be displayed by user selection. Inquiry mode for each of the above application, e.g., display of quantitative stress values associated with a component indicated as stressed, for example, by color coding. The inquiry mode may be initiated using, for example, mouse selection of a particular component or touch screen selection.

EExamples of vector animated graphics include, Shockwave™ by Macromedia which operates as a player for vector animated graphics and Flash™ by Macromedia which generates shockwave files. In the prior art, to achieve the same results as the invention, users must use an animation application, like Macromedi”'s Director™, to draw, assemble and animate the BHA. This process is time consuming, and the resulting movie will create a large file. Any changes require the user to manually edit the animation, possibly spending as much time as the initial creation.

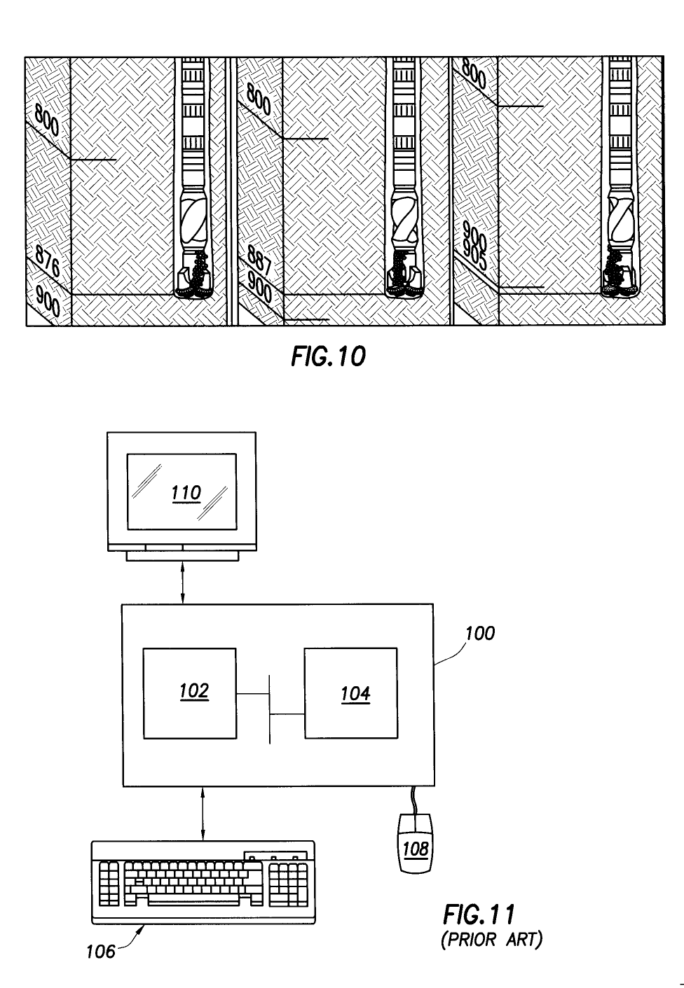

TThe invention provides a novel method of visualizing surface and down hole measurements by animating the measurement as it would affect the BHA, Well bore, and surrounding formations. FIG. 10 illustrates three frames of a sample situation where a BHA is animated as it drills a borehole in Rotary Drilling. Each frame depicts the components of the BHA defined by the BHA data source, the current formation type, trajectory inclination and cuttings density, provided by a down hole measurement tool, the rotation speed, pump flow rate, bit and hole depth provided by surface measurements. Each frame is drawn with respect to the data acquired at a given time and when updated in sequence provides a detailed animation of the effects those measurements have on the BHA, well bore and formation.

TThe invention provides the framework for animating any data that can be represented in time or depth that may or may not be related to a measurement. Additional possibilities includes displaying or animating information related to drilling hazards, drilling risks, and drilling events, such as bit-related information (e.g., bit balling, broken cutter, mechanical issues), formation-related information (e.g., fracture risks, formation stability, ballooning, pore pressure, pack off, etc.), borehole dynamics (e.g., gas kicks, water influx, swab, surge, etc.), well-related information (e.g., well collisions, close approach, hole cleaning, collapse, cutting buid up, wash out, break out), drill string-related information (e.g., stuck pipe, twist off, torque, drag, shocks, vibration, etc.). In addition, embodiments of the invention may be used to display and animate information related to well data, such as well completions (e.g., casing runs, gavel packing, and perforations, etc.), production/reservoir monitoring, wireline or LWD logging, etc.

EEmbodiments of the invention may be implemented on any computer. FIG. 11 shows a general computer that may be used with embodiments of the invention. As shown, the computer includes a display 110, a main unit 100, and input devices such as a keyboard 106 and a mouse 108. The main unit 100 may include a central processor 102 and a memory 104. The memory 104 may store programs having instructions for performing methods of the invention. Alternatively, other internal or removable storage may be used, such as a floppy disk, a CD ROM or other optical disk, a magnetic tape, a read-only memory chip (ROM), and other forms of the kind known in the art or subsequently developed. The program of instructions may be in object codes or source codes. The precise forms of the program storage device and of the encoding of instructions are immaterial here.

TThe advantages of embodiments of the invention may include one or more of the following. Embodiments of the invention do not rely on a library of components drawn in raster format, like bitmaps or jpegs. While these formats can produce BHA Graphics with good quality, they cannot maintain the same quality when scaled. This prevents a BHA from being rendered in true scale. Instead, embodiment of the invention uses vector graphics, the components of which are drawn using mathematical formulas. The vector graphics makes it possible to render the components in true scale, while maintaining a high quality of detail.

EEmbodiments of the invention do not require a user to piece together each individual component to form the BHA. This process can take hours and requires manual modifications if the BHA should change. Embodiments of the invention will automatically draw the BHA without user intervention based on the data provided in the WITSML data source. Embodiments of the Invention will refresh the drawing every time the data source is modified; therefore, any changes will be displayed almost immediately.

EEmbodiments of the invention do not manually create BHAs by drawing the components and animating the BHA frame by frame, as done in the prior art methods. With the prior art methods, any changes must be made manually by the user, which could take as many hours as the initial movie, and any modifications will require the movie to be recompiled and redistributed. In contrast, movies created by methods of the invention are completely dynamic and completed in a few seconds. Any changes made to the data source will immediately be reflected in the movie. The generation of the movie is completely automatic and requires no user intervention. A single copy of the control can display any number of different movies; all that”s required are different data sources.

PPrior art methods for displaying BHA create large files. With decent quality, the resulting one-minute movie may be over 30 megabytes. In contrast, movies generated with methods of the invention are typically less than 100 K and can easily animate an hour”s worth of data. Because the data is stored in a WITSML file or streamed through a Socket, embodiments of the invention only require the memory space taken up by the component library and internal components.

PPrior art methods for displaying BHA require large files. The libraries used by existing applications contain components drawn in a raster format. This format usually results in large files if rendered with decent quality. In contrast, embodiments of the invention use vector drawn components, resulting in very small file sizes even when rendered with high quality and detail.

PPrior art methods for displaying BHA are platform dependent and require special applications to generate and display the graphics. In contrast, embodiments of the invention is platform independent and completely portable. Since WISTML is basically text, it can be transferred to any platform. The invention can run in any Shockwave enabled web browser (97% of web browsers are Shockwave enabled). The result is a dynamic, animated BHA that can be created and displayed using only a text editor and web browser.

PPrior methods for viewing down hole and surface measurements are accomplished by viewing the data in a log format. Each measurement is displayed as a graphical line relative to time (similar to a stock ticker). To determine simple drilling modes requires monitoring a multitude of measurements. This invention represents the down hole and surface measurements with an animated graphic that provide a detailed visualization of the effects each measurement has on the BHA.

WWhile the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for displaying a bottom-hole assembly (BHA) using vector graphics, comprising:
parsing and interpreting BHA source data to produce data packets corresponding to BHA components;
assembling the BHA using vector graphics components in a vector graphics library, wherein the vector graphics components represent the BHA components; and
displaying the BHA at a selected scale.

2. The method of claim 1, wherein the BHA source data are in a WITSML data file or a text file.

3. The method of claim 1, wherein the displaying further displays the BHA source data.

4. The method of claim 3, wherein the displayed BHA source data and the displayed BHA are in separate windows.

5. The method of claim 1, wherein the parsing and the interpreting the BHA source data further produce data corresponding to well log data, and the displaying further displays the data corresponding to the well log data.

6. The method of claim 5, wherein the well log data comprise at least one selected from the group consisting of a weight on bit, a rate of rotation, a rate of penetration, torques experienced by the BHA, drags experience by the BHA, shocks experienced by the BHA, and stresses associated with the BHA components.

7. The method of claim 5, wherein the well log data comprise at least one selected from the group consisting of gamma ray data, nuclear magnetic resonance data, formation resistivity data, formation porosity data, and formation type data.

8. The method of claim 1, wherein the displaying further comprises displaying data corresponding to well log data, wherein the well log data are not included in the BHA source data.

9. The method of claim 8, wherein the well log data comprise at least one selected from the group consisting of a weight on bit, a rate of rotation, a rate of penetration, torques experienced by the BHA, drags experience by the BHA, shocks experienced by the BHA, and stresses associated with the BHA components.

10. The method of claim 8, wherein the well log data comprise at least one selected from the group consisting of gamma ray data, nuclear magnetic resonance data, formation resistivity data, formation porosity data, and formation type data.

11. The method of claim 1, further comprising animating the displayed BHA.

12. The method of claim 12, wherein the animating is based on information related to a well trajectory or time-versus-depth data.

13. The method of claim 13, wherein the information is included in the BHA source data.

14. The method of claim 13, wherein the information is not included in the BHA source data.

15. The method of claim 15, wherein the information is streamed from a well logging operation.

16. The method of claim 1, wherein the parsing and the interpreting the BHA source data further produce data packets corresponding to a drill string that is attached to the BHA, wherein the assembling further comprises assembling the drill string using vector graphics components that represent drill string components, and wherein the displaying further displays the drill string.

17. The method of claim 16, further comprising animating the displayed drill string and BHA.

18. The method of claim 17, wherein the animating is based on information related to a well trajectory or time-versus-depth data.

19. The method of claim 18, wherein the information is included in the BHA source data.

20. The method of claim 18, wherein the information is not included in the BHA source data.

21. The method of claim 20, wherein the information is streamed from a drilling operation.

22. The method of claim 18, wherein the animating further displays data related to one selected from formation data, borehole data, and BHA data.

23. The method of claim 22, wherein the data selected from the formation data, the borehole data, and the BHA data is streamed from a drilling operation.

24. The method of claim 1, further comprising displaying a borehole surrounding the BHA.

25. The method of claim 24, further comprising animating the displayed BHA along the borehole.

26. The method of claim 24, wherein the borehole is displayed as cylinder sections.

27. The method of claim 26, the cylinder sections of the borehole are displayed in sequence to simulate a drilling process.

28. The method of claim 27, further comprising animating the displayed BHA to simulate the drilling process.

29. A system for displaying a bottom-hole assembly (BHA) using vector graphics, comprising a processor and a memory, wherein the memory stores a program having instructions for:
parsing and interpreting BHA source data to produce data packets corresponding to BHA components;
assembling the BHA using vector graphics components in a vector graphics library, wherein the vector graphics components represent the BHA components; and
displaying the BHA at a selected scale.
